(19) United States
(12) Patent Application Publication
(10) Pub. No.: US 2010/0075203 A1
(43) Pub. Date: Mar. 25, 2010

(54) MEMBRANE-ELECTRODE UNIT COMPRISING A BARRIER JUNCTION

(75) Inventors: Sigmar Braeuninger, Hemsbach (DE); Sven Thate, Taipei (TW); Ekkehard Schwab, Neustadt (DE); Alexander Panchenko, Ludwigshafen (DE); Stefan Kotrel, Speyer (DE); Oemer Uensal, Mainz (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, LUDWIGSHAFEN (DE)

(21) Appl. No.: 12/444,464

(22) PCT Filed: Sep. 14, 2007
(86) PCT No.: PCT/EP07/59689

§ 371 Date: Apr. 6, 2009

(30) Foreign Application Priority Data
Oct. 5, 2006 (EP) 06121837.6

(51) Int. Cl. H01M 4/86; H01M 4/88

(52) U.S. Cl. 429/40; 427/115

(57) ABSTRACT

The present invention relates to a membrane-electrode assembly comprising at least one membrane, at least two electrode layers and at least one barrier layer, wherein the at least one barrier layer comprises at least one catalytically active species and/or at least one adsorbent material and the barrier layer is electronically nonconductive when a catalytically active species is present, the use of such a barrier layer in a membrane-electrode assembly and in a fuel cell, and also a gas-diffusion electrode and a fuel cell comprising such a membrane-electrode assembly.

The present invention relates to a membrane-electrode assembly comprising at least one membrane, at least two electrode layers and at least one barrier layer, wherein the at least one barrier layer comprises at least one catalytically active species and/or at least one adsorbent material and the barrier layer is electronically nonconductive when a catalytically active species is present, the use of such a barrier layer in a membrane-electrode assembly and the use of such a membrane-electrode assembly in a fuel cell.

In the present description, the term “electronic conductivity” refers to the ability of materials to conduct electrons. In contrast, the term “ionic conductivity” refers to the ability to transport ions, e.g. protons. “Electrical conductivity” is used as collective term to cover any type of electronic and ionic conductivity.

Fuel cells are energy transformers which convert chemical energy into electric energy. In a fuel cell, the principle of electrolysis is reversed. Various types of fuel cells which generally differ from one another in the operating temperature are now known. However, the structure of all these types of cells is in principle the same. They are generally made up of two electrode layers, viz. an anode and a cathode, at which the reactions proceed and an electrolyte in the form of a membrane between the two electrodes. This membrane has three functions. It establishes ionic contact, prevents electronic contact and also serves to keep the gases supplied to the electrode layers separate. The electrode layers are generally supplied with gases which are reacted in a redox reaction. For example, the anode is supplied with hydrogen and the cathode is supplied with oxygen. To achieve this, the electrode layers are usually in contact with electronically conductive gas diffusion layers. These are, for example, plates having a grid-like surface structure comprising a system of fine channels. The overall reaction can in all fuel cells be broken up into an anodic substep and a cathodic substep. In terms of the operating temperature, the electrolyte used and the possible fuel gases, there are differences between the various types of cells.

According to the present-day state of the art, all fuel cells have gas-permeable, porous, so-called three-dimensional electrodes. These are referred to by the collective term gas diffusion electrodes (GDE) and comprise the gas diffusion devices and the electrode layer. The respective reaction gases are conveyed through the gas diffusion layers to close to the membrane, viz. the electrolyte. Adjoining the membrane are electrode layers in which catalytically active species which catalyze the reduction or oxidation reaction are generally present. The electrolyte present in all fuel cells ensures ionic transport of electric current in the fuel cell. In addition, it has the function of forming a gastight barrier between the two electrodes. In addition, the electrolyte guarantees and promotes a stable 3-phase layer in which the electrolytic reaction can take place. The polymer electrolyte fuel cell uses organic ion-exchange membranes, in the cases implemented in industry especially perfluorinated cation-exchange membranes, as electrolytes. A membrane-electrode assembly, which is generally made up of a membrane and two electrode layers which each adjoin one side of the membrane, is referred to as a membrane-electrode assembly or MEA.

During operation of the fuel cell, disturbance of the function and/or destruction of the MEA or the entire fuel cell can occur as a result of by-products of the oxidation and/or reduction reaction or substances present in the individual regions of the MEA.

The effect of such interfering components which are either formed in the electrode layer or affect the function of the electrode layer has to be neutralized in order to ensure smooth operation of the fuel cell. A general distinction may be made between interfering components which act reversibly and those which act irreversibly. Interfering components which act reversibly participate directly in the electrochemical process at the electrode surfaces and lead to additional polarization of a fuel cell electrode. However, permanent damage to the fuel cell does not occur. On the other hand, inferring components which act irreversibly permanently damage the ability of a fuel cell to function and lead to permanent changes at the fuel cell materials used. The reversible poisoning of the anode by carbon monoxide in H₂-PEMFC operation and the unintended combustion of methanol which reaches the cathode as a result of methanol permeability of the membrane (methanol crossover) are examples of interfering components which act reversibly. The cathodic production of peroxides, in particular H₂O₂, during the reduction of oxygen is an example of the formation of an interfering component which acts irreversibly, since H₂O₂ which reaches the membrane can cause degradation of the polymer.

Highly reactive peroxidic oxygen species (for example HO., HOO.) are formed at the cathodic electrode material of the fuel cell as described in the prior art and these can diffuse to the proton-permeable membrane and irreversibly damage this. Such degradation processes are described, for example, in EPR investigation of HO. radical initiated degradation reactions of sulfonated aromatics as model compounds for fuel cell proton conducting membranes, G. Hübner, E. Roduner, J. Mater. Chem., 1999, 9, pp. 409-418.

Owing to these degradation processes, the use of perfluorinated cation-exchange materials as electrolyte is necessary at present. Although these materials have some resistance toward peroxidic species, they have the disadvantages of high costs, the complicated production resulting from the handling of fluorine or other fluorinating agents and are ecologically problematical since work-up and/or recycling are very complicated.

Furthermore, it is known that contain portions of the noble metal from the electrode layer can go into solution during operation of the fuel cell as a result of electrode polarization and the low pH and migrate into the membrane or to the opposite electrode layer. These dissolved noble metal species can cause a number of problems. Firstly, the cations can neutralize the polar groups, e.g. sulfonic acid groups, of the electrolyte membrane. This significantly reduces the ion conductivity of the system. In addition, cationic noble metal species, e.g. platinum cations, can migrate into the membrane and be reduced to metal again by hydrogen which is present. This elemental noble metal is then a catalytically active center which can become a starting point for attack on or destruction of the polymer membrane.

In an extreme case, cationic species can also migrate through the membrane and cause damage at the opposite electrode. For example, it is known that ruthenium which has dissolved under fuel cell conditions in direct methanol fuel cells migrates through the membrane to the opposite cathode layer and deposits there. The ruthenium deposited on the cathode can have a tremendous adverse effect on the electrochemical function of the cathode, see Piela, P.; Eickes, C.; Brosha, E.; Arzon, F.; Elenay, P. Ruthenium Crossover in Direct Methanol Fuel Cell with Pt—Ru Black Anode, Journal of the electrochemical society 2004, 151, A2053-A2059.

A further problem in operation of a fuel cell is the diffusion of organic fuel molecules through the membrane to the cathode (crossover), which occurs when a fuel cell is operated using organic, water-soluble fuels. As a result, the organic molecule undergoes direct combustion with oxygen to form carbon dioxide and water at the catalytically active site of the cathode catalyst. The active sites occupied by the combustion of organic molecules are no longer available for the actual electrochemical reaction, viz. the electrochemical reduction of oxygen, so that the overall activity of the cathode layer decreases. In addition, the direct oxidation of the organic molecule by oxygen reduces the electrochemical potential of the cathode layer and reduces the total voltage which can be tapped from the fuel cell. Since oxygen reduction and oxidation of the organic molecule proceed at the same electrochemically active site, a mixed potential which is lower than that of the reduction of oxygen arises. The driving force (EMF) is reduced and the total cell voltage and thus the power are decreased.

In the past, processes and apparatuses which neutralize the abovementioned interfering components or prevent migration of substances have been developed.

To suppress the poisoning of hydrogen-PEM anode electrodes by carbon monoxide, EP 1 155 465 A1 proposes an anode structure in which two catalysts having different compositions are functionally connected. According to EP 1 155 465 A1, a functional connection between two catalysts is ionic contact between two catalytic components. This contact can, for example, be produced by use of an ionomer. In an embodiment of EP 1 155 465 A1, the two components can be applied in two separate but functionally connected layers to one side of the fuel cell membrane. The catalysts according to the invention display a higher tolerance to carbon monoxide than would have been expected from the carbon monoxide tolerances of the individual components. The second component according to EP 1 155 465 thus acts as an additive which increases the tolerance of the catalyst to carbon monoxide.

U.S. Pat. No. 4,438,216 discloses a method of suppressing the cathodic formation of hydrogen peroxide. According to this, the damaging action of hydrogen peroxide, which is formed as an intermediate in the cathodic reduction of oxygen in fuel cells, can be reduced by means of an additive if this additive prevents the formation of peroxides or decomposes peroxides which have been formed. In this case, the catalytic component which attacks the hydrogen peroxide is intimately mixed with the actual electrocatalyst in the electrode layer. In terms of the functioning of the electrode layer, it is not possible to make a distinction between the actual electrochemical reaction and the suppression of the interfering component. Aluminum-heavy metal spinel compounds which have a ratio of aluminum to heavy metal of at least 2:1 are used as additives which suppress the formation of hydrogen peroxide.

US 2004/0043283 A1 discloses an MEA which comprises a catalyst which decomposes hydrogen peroxide in the anode, cathode or membrane or in at least one layer between membrane and cathode or membrane and anode. The catalyst can be applied to a support material selected from among carbon and various oxides, with the layer according to US 2004/0043283 A1 being connected in an electronically conductive manner with the other constituents of the MEA.

Various methods of suppressing the unwanted oxidation of methanol at the DMFC cathode are disclosed in the prior art. In the case of the direct methanol fuel cell (DMFC), part of the fuel crosses by diffusion from the anode side to the cathode side. This phenomenon is referred to as methanol crossover.

U.S. Pat. No. 5,919,583 and U.S. Pat. No. 5,849,428 disclose methods of reducing the methanol crossover. For this purpose, inorganic fillers, for example titanium dioxide, tin and mordenite in protonated form, oxides and phosphates of zirconium and mixtures thereof or zirconyl phosphate, are introduced into the pores of the polymer electrolyte matrix.

US 2005/0048341 A1 teaches that greater crosslinking of the polymer electrolyte membrane reduces the methanol permeability. Covalent crosslinking of ionically conductive materials can be effected by means of sulfonic acid groups. Unfluorinated materials such as aromatic polyether ketones and polyether sulfones and also fluoride polymers can be crosslinked in this way.

In US 2004/024150 A1, methanol crossover is reduced mechanically by coating a polymer electrolyte membrane with thin, inorganic layers by means of PECVD (plasma enhanced chemical vapor deposition). According to US 2004/0241520 A1, silicon dioxide, titanium dioxide, zirconium dioxide, zirconium phosphate, zeolites, silicalites and aluminum oxides are used as inorganic layer materials.

The methods disclosed in the prior art for avoiding migration of the interfering components mentioned within the membrane-electrode assemblies have the disadvantages that the electrocatalyst is inevitably diluted by addition of an additive so that a thicker electrode layer has to be used in order to be able to ensure a sufficiently high activity per unit area of the membrane or that the methods described lead to membranes which have not only a reduced methanol permeability but also a reduced ionic conductivity, as a result of which the performance of the membrane-electrode assembly is adversely affected. Furthermore, the electronically conductive compound of the barrier layer with the adjacent electrode layer disclosed in the prior art has the disadvantage that mixed potentials are formed at the electrode layers and reduce the voltage able to be tapped from the MEA and thus reduce the performance of the fuel cell.

It is an object of the present invention to neutralize the adverse effects of interfering components and thus avoid the impairments of the fuel cell function mentioned in the prior art in terms of ionic conductivity, thickness of the electrocatalyst layer, performance of the fuel cell or uniform polarization of the electrode layer.

This object is achieved according to the invention by a membrane-electrode assembly comprising at least one membrane, at least two electrode layers and at least one barrier layer, wherein the at least one barrier layer comprises at least one catalytically active species and/or at least one adsorbent material and the barrier layer is electronically nonconductive when a catalytically active species is present.

An MEA is generally made up of a membrane functioning as electrolyte and two electrode layers bearing electrocatalytically active substances adjoining this membrane.

In a preferred embodiment, the membrane of the MEA of the invention comprises one or more ion-conducting polymers (ionomers). This polymer electrolyte membrane material can be made up of one or more components, e.g. a plurality of ionomers.

Suitable ionomers are known to those skilled in the art and are disclosed, for example, in WO 03/054991.

Preference is given to using at least one ionomer having sulfonic acid, carboxylic acid and/or phosphonic acid groups. Suitable ionomers having sulfonic acid, carboxylic acid and/or phosphonic acid groups are known to those skilled in the art. For the purposes of the present invention, sulfonic acid, carboxylic acid and/or phosphonic acid groups are groups of the formulae —SO₃X, —COOX and —PO₃X₂, where X is H, NH₄⁺, NH₃R⁺, NH₂R₃⁺, NHR₃⁺ or NR₄⁺, where R is any radical, preferably an alkyl radical, which may optionally have one or more further radicals which can release protons under the conditions customarily present in fuel cells.

Preferred ionomers are, for example, polymers which comprise sulfonic acid groups and are selected from the group consisting of perfluorinated sulfonated hydrocarbons such as Nafion® from E.I. DuPont, sulfonated aromatic polymers such as sulfonated polyaryl ether ketones such as polyether ether ketones (sPEEK), sulfonated polyether ketones (sPEK), sulfonated polyether ketone ketones (sPEKK), sulfonated polyether ether ketone ketones (sPEEKK), sulfonated polyarylene ether sulfones, sulfonated poly-benzobisbenzazoles, sulfonated polybenzothiazoles, sulfonated polybenzimidazoles, sulfonated polyamides, sulfonated polyetherimides, sulfonated polyphenylene oxides, e.g. poly-2,6-dimethyl-1,4-phenylene oxides, sulfonated polyphenylene sulfides, sulfonated phenol-formaldehyde resins (linear or branched), sulfonated polystyrenes (linear or branched), sulfonated polyphenylenes and further sulfonated aromatic polymers.

The sulfonated aromatic polymers can be partially fluorinated or perfluorinated. Further sulfonated polymers comprise polyvinylsulfonic acids, copolymers made up of acrylonitrile and 2-acrylamido-2-methyl-1-propanesulfonic acids, acrylonitrile and vinylsulfonic acids, acrylonitrile and styrenesulfonic acids, acrylonitrile and methacryl-oxyethyleneoxypropanesulfonic acids, acrylonitrile and methacryloxyethylenoxy-tetrafluoroethylenesulfonic acids, etc. The polymers can once again be partially fluorinated or perfluorinated. Further groups of suitable sulfonated polymers comprise sulfonated polyphosphazenes such as poly(sulfophenoxy)phosphazenes or poly(sulfoethoxy)phosphazenes. The polyphosphazene polymers can be partially fluorinated or perfluorinated. Sulfonated polyphenylsiloxanes and copolymers thereof, poly(sulfoalkoxy)phosphazene, poly(sulfotetrafluoroethoxypropoxy)siloxanes are likewise suitable.

Examples of suitable polymers comprising carboxylic acid groups comprise polyacrylic acid, polymethacrylic acid and any copolymers thereof. Suitable polymers are, for example, copolymers comprising vinylimidazole or acrylonitrile. The polymers can once again be partially fluorinated or perfluorinated.

Suitable polymers comprising phosphonic acid groups are, for example, polyvinyl-phosphonic acid, polybenzimidazolephosphonic acid, phosphonated polyphenylene oxides, e.g. poly-2,6-dimethylphenylene oxides, etc. The polymers can be partially fluorinated or perfluorinated.

In addition to cation-conducting polymers, it is also possible to conceive of anion-conducting polymers so as to give alkaline arrangements of membrane-electron assemblies in which hydroxy ions can effect ion transport. These carry, for example, tertiary amine groups or quaternary ammonium groups. Examples of such polymers are described in U.S. Pat. No. 6,183,914; JP-A 11273695 and in Slade et al., J. Mater. Chem. 13 (2003), 712-721.

Furthermore, acid-based blends as are disclosed, for example, in WO 99/54389 and WO 00/09588 are suitable as ionomers. These are generally polymer mixtures comprising a polymer comprising sulfonic acid groups and a polymer having primary, secondary or tertiary amino groups, as are disclosed in WO 99/54389, or polymer mixtures obtained by mixing polymers comprising basic groups in the side chain with polymers comprising sulfonate, phosphonate or carboxylate groups (acid or salt form). Suitable polymers comprising sulfonate, phosphonate or carboxylate groups have been mentioned above (see polymers comprising sulfonic acid, carboxylic acid or phosphonic acid groups). Polymers comprising basic groups in the side chain are polymers which are obtained by side chain modification of aryl main chain engineering polymers which have arylene-containing N-basic groups and can be deprotonated by means of organometallic compounds, where aromatic ketones and aldehydes comprising tertiary basic N groups (e.g. tertiary amine or basic N-comprising heterocyclic aromatic compounds such as pyridine, pyrimidine, triazine, imidazole, pyrazole, triazole, thiazole, oxazole, etc) are connected to the metallated polymer. Here, the metal alkoxide formed as an intermediate can, in a further step, either be protonated by means of water or etherified by means of haloalkanes, see WO 00/09588.

The abovementioned polymer electrolyte membrane materials (ionomers) can also be crosslinked. Suitable crosslinking reagents are, for example, epoxide crosslinkers such as the commercially available Decanols®. Suitable solvents in which crosslinking can be carried out can be chosen as a function of, inter alia, the crosslinking reagent and the ionomers used. Examples of suitable solvents are aprotic solvents such as DMAc (N,N-dimethylacetamide), DMF (dimethylformamide), NMP (N-methylpyrrolidone) and mixtures thereof. Suitable crosslinking methods are known to those skilled in the art.

Preferred ionomers are the abovementioned polymers comprising sulfonic acid groups. Particular preference is given to perfluorinated sulfonated hydrocarbons such as Nafion®, sulfonated aromatic polyether ether ketones (sPEEK), sulfonated polyether ether sulfones (sPES), sulfonated polyetherimides, sulfonated polybenzimidazoles, sulfonated polyether sulfones and mixtures of the polymers mentioned. Particular preference is given to perfluorinated sulfonated hydrocarbons such as Nafion® and sulfonated polyether ether ketones (sPEEK). These can be used either alone or in mixtures with other ionomers. It is likewise possible to use copolymers which comprise blocks of the abovementioned polymers, preferably polymers comprising sulfonic acid groups. An example of such a block copolymer is sPEEK-PAMD.

The degree of functionalization of the ionomers comprising sulfonic acid, carboxylic acid and/or phosphonic acid groups is generally from 0 to 100%, preferably from 30 to 70%, particularly preferably from 40 to 60%.

Particularly preferred sulfonated polyether ether ketones have degrees of sulfonation of from 0 to 100%, preferably from 30 to 70%, particularly preferably from 40 to 60%. Here, a sulfonation of 100% or a functionalization of 100% means that each repeating unit of the polymer comprises a functional group, in particular a sulfonic acid group.

The abovementioned ionomers can be used either alone or in mixtures in the polymer electrolyte membranes according to the invention. Here, it is possible to use mixtures which comprise not only the at least one ionomer but also further polymers or other additives, e.g. inorganic materials, catalysts or stabilizers.

Methods of preparing the ion-conducting polymers mentioned as suitable ionomer are known to those skilled in the art. Suitable methods of preparing sulfonated polyaryl ether ketones are disclosed, for example, in EP-A 0 574 791 and WO 2004/076530.

Some of the ion-conducting polymers mentioned are commercially available, e.g. Nafion® from E.I. DuPont. Further suitable commercially available materials which can be used as ionomers are perfluorinated and/or partially fluorinated polymers such as “Dow Experimental Membrane” (Dow Chemicals USA), Aciplex® (Asahi Chemicals, Japan), Raipure R-1010 (Pall Rai Manufacturing Co. USA), Flemion (Asahi Glas, Japan) and Raymion® (Chlorin Engineering Cop., Japan).

Further suitable constituents of the ion-conducting polymer electrolyte membranes according to the invention are, for example, inorganic and/or organic compounds in the form of low molecular weight or polymeric solids which are able, for example, to take up or release protons. The inorganic and/or organic compounds listed below can serve as filler particles.

Examples of suitable compounds of this type are:
SiO₂ particles which may, for example, be sulfonated or phosphorylated.
Sheet silicates such as bentonites, montmorillonites, serpentine, calinite, talc, pyrophyllite, mica, for further details see Hollemann-Wiberg, Lehrbuch der Anorganischen Chemie, 91st-100th edition, p. 771 ff (2001).
Aluminosilicates such as zeolites.
Water-insoluble organic carboxylic acids, for example ones having from 5 to 30, preferably from 8 to 22, particularly preferably from 12 to 18, carbon atoms and a linear or branched alkyl radical which may, if appropriate, comprise one or more further functional groups such as, in particular, hydroxyl groups, C—C double bonds or carbonyl groups, for example valeric acid, isovaleric acid, 2-methyl-butyric acid, pivalic acid, caproic acid, enanthic acid, caprylic acid, pelargonic acid, capric acid, undecanoic acid, lauric acid, tridecanoic acid, myristic acid, pentadecanoic acid, palmitic acid, margaric acid, stearic acid, nonadecanoic acid, arachic acid, behenic acid, lignoceric acid, cerotinic acid, melissic acid, tuberculo-stearic acid, palmitoleic acid, oleic acid, erucic acid, sorbic acid, linoleic acid, linolenic acid, elaeostearic acid, arachidonic acid, culpanodonic acid and docosahexanoic acid or mixtures of two or more thereof.
Polyphosphoric acids as are described, for example, in Hollemann-Wiberg, loc. cit., p. 659 ff.; mixtures of two or more of the abovementioned solids.
Zirconium phosphates, zirconium phosphonates, heteropolyacids.

Suitable polymers which do not conduct ions, namely polymers which do not comprise sulfonic acid, carboxylic acid or phosphonic acid groups, are, for example:
Polymers having an aromatic backbone, for example polyimides, polysulfones, polyether sulfones, e.g. Ultrason®, polybenzimidazoles.
Polymers having a fluorinated backbone, for example Teflon® or PVDF.
Thermoplastic polymers or copolymers such as polycarbonates, e.g. polyethylene carbonate, polypropylene carbonate, polybutadiene carbonate or polyvinylidene carbonate, or polyurethanes, as are described, inter alia, in WO 98/44576.
Crosslinked polyvinyl alcohols.
Vinyl polymers such as
   Polymers and copolymers of styrene or methylstyrene, of vinyl chloride, of acrylonitrile, of methacrylonitrile, of N-methylpyrrolidone, of N-vinyl-imidazole, of vinyl acetate, of vinylidene fluoride.
   Copolymers composed of vinyl chloride and vinylidene chloride, vinyl chloride and acrylonitrile, vinylidene fluoride and hexafluoropropylene.
   Terpolymers composed of vinylidene fluoride and hexafluoropropylene plus a compound from the group consisting of vinyl fluoride, tetrafluoroethylene and trifluoroethylene.
Such polymers are disclosed, for example, in U.S. Pat. No. 5,540,741, whose relevant disclosure is fully incorporated by reference into the present patent application.
Phenol-formaldehyde resins, polytrifluorostyrene, poly-2,6-diphenyl-1,4-phenylene oxide, polyaryl ether sulfones, polyarylene ether sulfones, phosphonated poly-2,6-dimethyl-1,4-phenylene oxide.
Homopolymers, block copolymers and random copolymers prepared from:
   Olefinic hydrocarbons such as ethylene, propylene, butylene, isobutene, propene, hexene or higher homologues, butadiene, cyclopentene, cyclohexene, norbornene, vinylcyclohexane.
   Acrylic esters or methacrylic esters such as methyl, ethyl, propyl, isopropyl, butyl, isobutyl, hexyl, octyl, decyl, dodecyl, 2-ethylhexyl, cyclohexyl, benzyl, trifluoromethyl or hexafluoropropyl esters or tetrafluoropropyl acrylate or tetrafluoropropyl methacrylate.
   Vinyl ethers such as methyl, ethyl, propyl, isopropyl, butyl, isobutyl, hexyl, octyl, decyl, dodecyl, 2-ethylhexyl, cyclohexyl, benzyl, trifluoromethyl or hexafluoropropyl or tetrafluoropropyl vinyl ethers.

The abovementioned polymers which do not conduct ions can be used in crosslinked or uncrosslinked form.

Methods of preparing the polymers which do not conduct ions are known to those skilled in the art. Some of the abovementioned polymers which do not conduct ions are commercially available.

In MEAs according to the prior art, one or two catalyst layers (electrode layers) are applied to the ion-conducting polymer electrolyte membrane, with one being applied to the upper side of the polymer electrolyte membrane and, if appropriate, a further catalyst layer being applied to the underside of the polymer electrolyte membrane. The application of catalyst layers to polymer electrolyte membranes is known to those skilled in the art and is explained below.

In the MEA of the invention, at least one barrier layer is present in addition to the membrane and the electrode layers (catalyst layers). This at least one barrier layer is, in a preferred embodiment, present between an electrode layer and a membrane. It is possible, according to the invention, for only one barrier layer to be applied. However, it is also possible for a plurality of barrier layers to be present between membrane and electrode layer. To produce the MEA according to the invention, the at least one barrier layer is applied to the membrane before the electrode layers are applied. In a further embodiment, the catalyst layer is applied to the gas diffusion layer. The catalyst-coated gas diffusion layer is then placed on the membrane. A further possibility is the “decal process”. In this, the catalyst layer is firstly applied to an auxiliary film, known as the “release” film, and subsequently translaminated onto the membrane. Thus, there are in principle three techniques for applying a catalyst layer: direct formation on the membrane (“MP”), formation on the gas diffusion layer (“GP”) and the “decal process” (DP). This gives the following possible combinations for application of the intermediate layer (“I”) and the electrode layer (“E”):
I and E by MP
I and E by GP
I and E by two successive DPs
I by MP, E on GP
I by MP, E on DP
I by GP, Eon GP.

In a preferred embodiment, the MEA comprises one membrane, two electrode layers and one barrier layer.

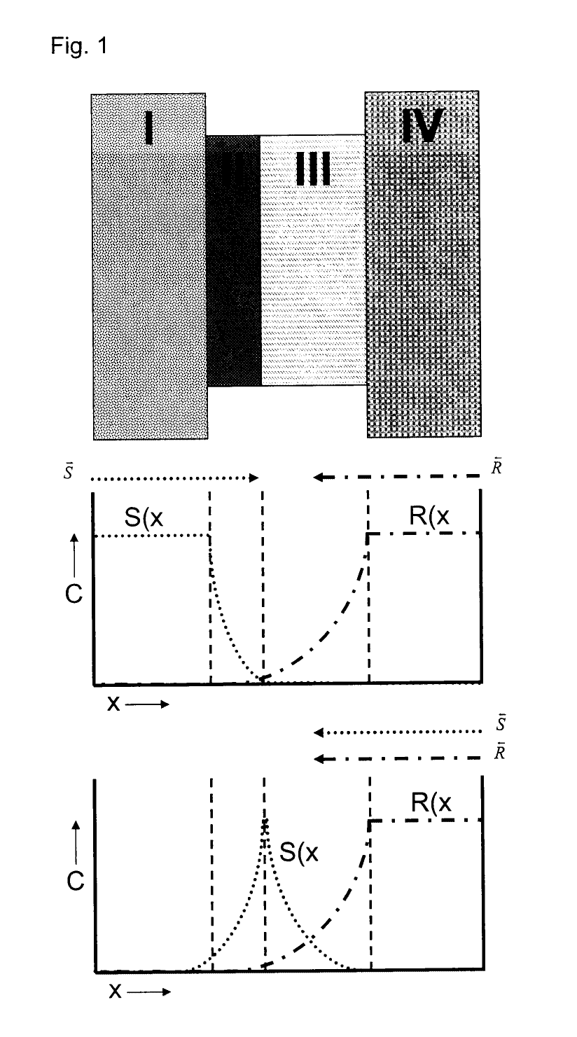

The at least one barrier layer according to the invention is, in a preferred embodiment, located between membranes and electrode layer. A membrane-electrode assembly which is preferred according to the invention is shown in FIG. 1. In this figure, the reference numerals have the following meanings:

### I Membrane

II Barrier layer
III Electrode layer
IV Electrode, e.g. gas diffusion electrode, gas diffusion layer

Between membrane I and electrode layer III there is, for example, a catalytic barrier layer II which is functionally, i.e. ionically conductively, connected to the membrane and the electrode layer. The electric current is taken off via the electrode IV. This barrier layer which comprises a catalytically active species and is electronically nonconductive is able to catalytically degrade an interfering component S. Examples of possible uses of the MEA of the invention are also shown in FIG. 1. Here, the symbols have the following meanings:

### C Concentration

x Path length in the MEA
S₍ₓ₎ Interfering component

### R₍ₓ₎ Reactants

S̅ Direction of movement of the interfering component
R̅ Direction of movement of the reactants
Broken line Boundary between layers
Dotted line Concentration of the interfering component
Dash and dot line Concentration of the reactants

The upper graph shows the change in concentration of the interfering component S₍ₓ₎ along the membrane-electrode assembly (x direction) when the electrocatalytic layer III is to be protected. The flow direction of the interfering component S is opposite to that of the reactant R. The lower graph shows the case when the membrane is to be protected against interfering components which are formed in the electrode layer. In this case, the flow directions of S and R are the same.

The barrier layer in the MEA of the invention can be matched to one or more interfering components depending on the interfering component(s) which is/are present and is/are to be removed. According to the invention, the barrier layer comprises catalytically active substances and/or adsorbent materials. In a preferred embodiment, the barrier layer comprises at least one catalytically active species and no adsorbent material. It is also possible, according to the invention, to use a barrier layer which comprises only catalytically active substances or only adsorbent materials or for a second barrier layer which may, if appropriate, comprise a further catalytically active substance or comprise a further, if appropriate, adsorbent material to adjoin this first barrier layer. However, it is also possible according to the invention for different catalytically active substances and/or different adsorbent materials to be present in a single barrier layer, so that various interfering components can be neutralized in one layer.

In a further preferred embodiment, the barrier layer comprises at least one catalytically active substance and at least one adsorbent material.

In an embodiment, the barrier layer according to the invention serves to prevent diffusion of peroxides formed as by-products in the cathode layer, for example hydrogen peroxide, from the cathode layer into the membrane so as to avoid destruction of the membrane polymers by peroxides.

During operation of the fuel cell, peroxides are generally formed during the reduction of oxygen, which can proceed by two mechanisms:

O₂+4H⁺+4e⁻→2H₂O (eq. 1)

O₂+2H⁺+2e⁻H₂O₂ (eq. 2)

Equation 1 describes the desired 4-electron mechanism in which exclusively the unreactive H₂O is formed. On the other hand, equation 2 describes the undesirable 2-electron mechanism in which the highly reactive H₂O₂ is formed. H₂O₂ can migrate into membranes and there cause permanent damage to the polymer structure of the membrane. The barrier layer according to the invention catalytically decomposes this H₂O₂ component to H₂O. The membrane is therefore lastingly protected against attack by H₂O₂.

A barrier layer according to the invention for the degradation of peroxides generally comprises at least one element or compound of groups IIIb, IVb, Vb, VIb, VIIb, VIIIb, Ib and IIb or a metallic element or compound of the 4th main group (IVa) of the Periodic Table of the Elements, preferably platinum and/or gold, as catalytically active species. These elements have the necessary deperoxidation-active properties. The deperoxidative elements can be present in either elemental or oxidic form. The elements and/or compounds can be present in heterogenized form in combination with a support substance. Possible support substances are, for example, natural oxides such as natural clays, silicates, aluminosilicates, kieselguhr, diatomite, pumice; synthetic metal oxides such as aluminum oxides, zinc oxides, cerium oxides, zirconium oxides; metal carbides such as silicon carbides; activated carbon of animal and vegetable origin; carbon black.

In a preferred embodiment, a deperoxidatively acting material, e.g. platinum or gold, is supported on an oxidic material, e.g. Al₂O₃ or SiO₂. The metal content can generally be in the range 1-80% by weight. The metal content is preferably in the range from 5 to 40% by weight, particularly preferably 10-20% by weight. The catalyst is subsequently converted into an ionomer-comprising ink and transferred to the membrane as barrier layer. The thickness of the barrier layer is generally 2-200 μm, preferably 10-100 μm, particularly preferably 20-40 μm. The weight ratio of ionomer to catalyst is generally 0.5-15, preferably 1-10, particularly preferably 3-8.

To avoid migration of organic fuel molecules within the MEA, the barrier layer according to the invention has, in a further embodiment, at least one suitable catalytically active species. This catalytically active substance degrades the corresponding organic molecules in the barrier layer, preferably oxidatively, before these can reach the actual electrocatalytic layer. Thus, it is not possible for fuel molecules to diffuse into the cathode layer and occupy the catalytically active sites. As a result, all catalytically active sites in the cathodic electrode layer remain available for the reduction of oxygen. Owing to the electronic insulation of the barrier layer according to the invention, there is also no voltage drop caused by mixed potential formation, since the oxidation is not electrochemical but purely catalytic.

The organic fuel cell molecules occurring as interfering components are, for example, alcohols such as methanol, ethanol, ethylene glycol, aldehydes such as formaldehyde, ethanal, glyoxylaldehyde and glycolic aldehyde or acids such as formic acid or acetic acid. These organic molecules can be the actual fuel or a partially oxidized product. According to the invention, it is also possible for mixtures of the interfering components mentioned to be catalytically, preferably oxidatively, oxidized in the barrier layer.

According to the invention, the barrier layer is not restricted to the oxidative degradation of the organic fuels but it is also possible, according to the invention, for hydrogen to be scavenged in an appropriate barrier layer.

A barrier layer according to the invention for the oxidative degradation of fuels generally comprises at least one metal selected from transition groups VI, VII, VIII, I and II of the Periodic Table of the Elements, i.e. at least one metal selected from the group consisting of Cr, Mo, W, Mn, Re, Fe, Co, Ni, Ru, Rh, Pd, Os, Ir, Pt, Cu, Ag, Au, Zn, Cd and Hg, as catalytically active species.

According to the invention, the barrier layer comprising a catalytically active species is electronically nonconductive. This can, in a preferred embodiment, be achieved by, for example, the proportion of catalytically active species to be kept so low that electronic conductivity is not present. The weight ratio of ionomer to catalytically active species is generally 2-9, preferably 3-7, particularly preferably 4-6.

In a further preferred embodiment, the catalytically active species can be applied to electronically nonconductive support materials. This results in the barrier layer being electronically nonconductive. Suitable support materials are, for example, oxidic species selected from the group consisting of oxides of Ru, Sn, Si, Ti, Zr, Al, Hf, Ta, Nb, Ce, zeolites, nitrides, carbides, silicates, aluminosilicates, spinels and carbon and mixtures thereof. Carbon is preferably used with a high sp³-hybridized fraction, e.g. as in many activated carbons. Carbon blacks and graphites are therefore not suitable. Even when nonconductive supports are used, the proportion of the usually conductive catalytically active components must not become too high. In the case of conventional oxidic supports, e.g. SiO₂ or CeO₂, a proportion of <30% by weight is generally preferred and a proportion of <20% by weight is particularly preferred.

As a result of the barrier layer according to the invention comprising a catalytically active species being nonconductive, the occurrence of mixed potentials at the electrode layers, which reduce the performance of the MEA and thus of the fuel cell, is avoided when the interfering component is quantitatively degraded in the barrier layer.

In a further embodiment, an MEA according to the invention can also comprise a barrier layer which neutralizes carbon monoxide by catalytic oxidation. As catalyst, it is possible to use, for example, elements of groups VIIIb, Ib and IIb of the Periodic Table of the Elements and their oxides, preferably Au, Pt, Pd, their oxides and mixtures thereof. These catalytically active species can likewise be present in supported form, with the support materials mentioned above being suitable. In a barrier layer for the neutralization of carbon monoxide, particular preference is given to using Au on cerium oxide as catalytically active species. A barrier layer for the neutralization of carbon monoxide is preferably arranged between anode and membrane.

Apart from the catalytically active species and, if appropriate, support materials, the barrier layer can have further constituents, for example ionomers which are required for ionic conductivity, fillers, for example ZrO₂, SiO₂, zeolites, silicon aluminates, carbides, and materials suitable as catalyst support and mixtures thereof. Suitable ionomers are the same ones described above for the membrane; preference is given to Nafion and SPEEK.

In a further embodiment, the present invention provides an MEA comprising at least one barrier layer comprising at least one absorbent material. Such an MEA can, for example, suppress the migration of noble metal cations.

A barrier layer according to the invention which can effectively suppress the migration of noble metal cations comprises a material having a very high adsorption capability for noble metal cations. Examples of materials having a very high adsorption capability are zeolites, cationic polymer ion-exchange resins, activated carbon or highly porous oxide structures. Preferred examples of suitable polymers are functionalized polyamides, polymetharylamides, polystyrenes and polyphenols. To act as acid ion exchangers, the polymers have to be functionalized with sulfonic acid groups or carboxyl groups. Examples are Amberlite® IRC 76, Duolite® C 433 or Relite® CC. As zeolites it is possible to use any type of protonated zeolites. To obtain a high ion-exchange capacity, a small modulus (SiO₂/Al₂O₃ ratio) is advantageous. Typical zeolites for this use would be faujasites, pentalites, beta zeolite, etc.

In general, a polymer (ionomer) which maintains ion conduction between electrode layer and membrane layer is mixed with the adsorbent. According to the invention, the affinity of the adsorbent for the dissolved metal has to be greater than the affinity of the ionomer for the metal so that the metal cations to be adsorbed are taken up by the adsorbent material and not by the ionomer. Uptake of metal cations by the ionomer would reduce the ionic conductivity of the ionomer. Ionomers suitable for this purpose are likewise those described for the membrane, for example Nafion or SPEEK.

A barrier layer which comprises only one adsorbent material and no catalytically active species can, according to the invention, be electronically conductive or electronically nonconductive, preferably electronically nonconductive.

The migrating ions can, according to the invention, be not only noble metal cations but also ionic interfering components such as Fe²⁺, Co²⁺, Ni²⁺, Cu²⁺ or Zn²⁺ and also organic cations. Organic cations, for example tertiary or quaternary amines, can be introduced into the electrode layer during production of the membrane-electrode assembly. Such organic additives usually serve the purposes of activation, pore formation or adjustment of the hydrophilicity/hydrophobicity of the electrode layer produced. Apart from cations, it is also possible for anions to occur as interfering components. Suitable anion-adsorbing materials are aminated polystyrenes and polyacrylic acids. Examples are Duolite® A 101, Duolite® A 102, Duolite® A 378, Duolite® A 365, Amberlyte® IRA 57, Amberlyte® IRA 458 and mixtures thereof.

The barrier layer according to the invention therefore has to comprise adsorbent materials which have a high affinity for the appropriate interfering components.

The at least one barrier layer of the MEA of the invention is applied to the membrane by methods known to those skilled in the art. In a preferred embodiment, this occurs before the electrode layer is applied, so that the barrier layer is preferably present between electrode layer and membrane.

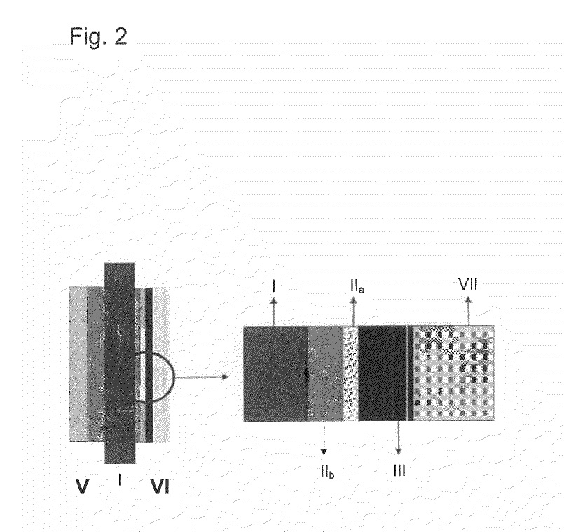

In a further possible embodiment of the present invention, the barrier layer can be electronically conductive. In this case, a further layer IIₐ which is firstly electronically nonconductive and secondly has no catalytic function is inserted between electrode layer and barrier layer II_{b}. This further layer ensures that the electrode layer III is not in electronic contact with the barrier layer II_{b} and occurrence of mixed potentials is avoided. The abovementioned intermediate layer IIₐ can comprise ionomer or ionomer together with a filler. If the filler is a porous material, gas can travel through this intermediate layer to the barrier layer and react there. The gas can either pass through the electrode layer into the intermediate layer or the gas concerned is supplied laterally to the intermediate layer. The further embodiment is shown in FIG. 2. The abbreviations used have the following meanings and correspond in part to the designations in FIG. 1:

### I Membrane

IIa Nonconductive intermediate layer
IIb Barrier layer comprising at least one catalytically active element, for example carbon, and ionomer
III Electrode layer

### V Anode

### VI Cathode

VII Gas diffusion layer

Suitable techniques for applying the barrier layer are known to those skilled in the art, for example printing, spraying, doctor blade coating, rolling, brushing and spreading. The barrier layer can also be applied by means of CVD, (chemical vapor deposition) or sputtering. A “decal” process in which the catalyst layer is firstly produced on a “release” film and is subsequently translaminated onto the membrane can also be used. In a manner analogous to the application of the catalyst layer, use is made of a homogenized ink which generally comprises, if appropriate, at least one catalytically active species, if appropriate applied to a suitable support, if appropriate at least one adsorbent material, at least one ionomer and at least one solvent for the application. Suitable catalytically active species, supports, adsorbent materials and ionomers have been mentioned above. Suitable solvents are water, monohydric and polyhydric alcohols, nitrogen-comprising polar solvents, glycols and also glycol ether alcohols and glycol ethers. Particularly suitable solvents are, for example, propylene glycol, dipropylene glycol, glycerol, ethylene glycol, hexylene glycol, dimethylacetamide, N-methylpyrrolidone and mixtures thereof.

To apply the electrode layers, one or two catalyst layer(s) from which the electrode layer(s) is/are formed by drying is/are preferably produced by application of catalyst ink. In a preferred embodiment, this occurs after at least one barrier layer has been applied to the membrane.

Suitable catalyst inks are known to those skilled in the art and generally comprise at least one electrocatalyst, at least one electron conductor, at least one polymer electrolyte and at least one solvent. The catalyst inks can also additionally comprise solid particles. Suitable solid particles have been mentioned above.

Suitable electrocatalysts are generally platinum group metals such as platinum, palladium, iridium, rhodium, ruthenium or mixtures or alloys thereof. These are generally present in the oxidation state 0 in the electrocatalyst. The catalytically active metals or mixtures of various metals can comprise further alloying additives such as cobalt, chromium, tungsten, molybdenum, vanadium, iron, copper, nickel, silver, gold, etc.

The platinum group metal used depends on the planned field of use of the finished fuel cell or electrolysis cell. If a fuel cell which is to be operated using hydrogen as fuel is produced, it is sufficient to use only platinum as catalytically active metal. In this case, the corresponding catalyst ink comprises platinum as active noble metal. This catalyst layer can be used both for the anode and for the cathode in a fuel cell. An H₂—PEM can also have PtCo alloy as catalytically active component on the cathode and PtRu alloy as catalytically active component on the anode.

On the other hand, if a fuel cell which uses a CO-comprising reformate gas as fuel is produced, it is advantageous for the anode catalyst to have a very high tolerance to poisoning by carbon monoxide. In such a case, preference is given to using electrocatalysts based on platinum/ruthenium. In the production of a direct methanol fuel cell, too, preference is given to using electrocatalysts based on platinum/ruthenium. To produce the anode layer in a fuel cell in such a case, preference is therefore given to the catalyst ink used comprising both metals. In this case, it is generally sufficient to use platinum alone as catalytically active metal for producing a cathode layer. It is thus possible for the same catalyst ink to be used for coating both sides of the ion-conducting polymer electrolyte membrane according to the invention with catalyst ink. However, it is likewise possible to use different catalyst inks for coating the surfaces of the ion-conducting polymer electrolyte membrane according to the invention.

The catalyst ink generally further comprises an electron conductor. Suitable electron conductors are known to those skilled in the art. The electron conductor is generally electronically conductive carbon particles. As electronically conductive carbon particles, it is possible to use all carbon materials which have a high electronic conductivity and a large surface area and are known in the field of fuel cells or electrolysis cells. Preference is given to using carbon blacks, graphite or activated carbons.

Furthermore, the catalyst ink preferably comprises a polyelectrolyte which can be at least one ionomer as described above. This ionomer is used in dissolved form or as dispersion in the catalyst ink. Preferred ionomers are the ionomers mentioned above.

Furthermore, the catalyst ink generally comprises a solvent or solvent mixture. Suitable solvents are those mentioned above in respect of the inks for the barrier layer.

The weight ratio of electron conductor (preferably conductive carbon particles) to polyelectrolyte (ionomer) in the catalyst ink is generally from 10:1 to 1:1, preferably from 4:1 to 2:1. The weight ratio of electrocatalyst to the electron conductor (preferably conductive carbon particles) is generally from 1:10 to 5:1.

The catalyst ink is generally applied in homogeneously dispersed form to the ion-conducting polymer electrolyte membrane according to the invention. To produce a homogeneously dispersed ink, it is possible to use known auxiliary equipment, e.g. high-speed stirrers, ultrasound, ball mills or shakers.

The homogenized ink can subsequently be applied to the ion-conducting polymer electrolyte membrane or the barrier layer according to the invention by means of various techniques. Suitable techniques are printing, spraying, doctor blade coating, rolling, brushing and spreading.

The catalyst layer applied is then preferably dried so that the electrode layer can form. Suitable drying methods are, for example, hot air drying, infrared drying, microwave drying, plasma processes and also combinations of these methods.

The present invention also provides the above-described process for producing the inventive MEA having a barrier layer, which comprises
(a) applying at least one barrier layer comprising at least one catalytically active substance and/or at least one adsorbent material to at least one side of a membrane, wherein the barrier layer is electronically nonconductive when a catalytically active substance is present, and subsequently
(b) applying an electrode layer to each side of the membrane.

The present invention also provides for the use of a barrier layer comprising a catalytically active substance and/or an adsorbent material, wherein the barrier layer is electronically nonconductive when a catalytically active substance is present, in a membrane-electrode assembly to avoid diffusion of peroxides from an electrode layer into the membrane, to avoid diffusion of metal cations from an electrode layer into the membrane and/or into a further electrode layer, to avoid diffusion of fuels to be reacted in the membrane-electrode assembly from an electrode layer into the membrane and/or into a further electrode layer or to avoid diffusion of carbon monoxide from an electrode layer into the membrane and/or into a further electrode layer, preferably in a fuel cell.

The present invention further provides a gas diffusion electrode (GDE) comprising a membrane-electrode assembly according to the invention.

The present invention further provides a fuel cell comprising a membrane-electrode assembly according to the invention.

The present invention is illustrated by the examples.

### EXAMPLES

### Example 1

### Preparation of an MeOH Oxidation Catalyst

225 g of Al₂O₃ powder (Puralox® SCF A-230) together with 7 l of water are placed in a round-bottom flask provided with a stirrer and heated to 60° C. 750 ml of an Au-comprising solution (58 g of HAuCl₄) and a 1 N Na₂CO₃ solution are then simultaneously added in such a way that the pH of the reaction solution can be maintained in the range 7.5-8. After addition of all the Au-comprising solution, the mixture is stirred for another 30 minutes and the catalyst is filtered off, washed with warm H₂O until free of Cl, dried and heated at 200° C. under H₂.

### Example 2

### Production of a Membrane Having a Barrier Layer for the Oxidation of MeOH

The catalyst described in Example 1 is processed with a 10% strength Nafion® solution to give an ink (ionomer to catalyst ratio=2:1) and sprayed onto a PEM membrane. The thickness of the barrier layer corresponds to a loading of 0.2 mg of Au/cm².

### Example 3

### Conductivity Measurement of Electrocatalysts and Barrier Layer Catalyst

About 0.5 and 1 g of catalyst sample are pressed at a pressure of 1000 kg/cm² to give a 13 mm thick pellet. A graphite layer (graphite used: Timcal (Switzerland) KS6) is subsequently pressed at a pressure of 300 kg/cm² onto the upper side of the pellet and the underside of the pellet. To carry out the conductivity measurement, the graphite/sample/graphite pellet is clamped between two Pt foils which act as power outlet leads. The resistance of the pellet is measured by means of impedance spectroscopy in a frequency range from 10 kHz to 10 Hz at a voltage amplitude of 10 mV. The measurement is carried out using an EG&G potentiostat (model 263A) in conjunction with an EG&G frequency detector (model 1025). The data are recorded at OCV (open circuit voltage) and room temperature.

The high-frequency impedance of the sample at a phase angle of 0° is employed for the determination of the conductivity (the impedance is corrected for the influence of the graphite layer and all other connection compounds). The specific conductivity is calculated according to the following formula:

σ=d/(Z*A), where

σ specific conductivity
d sample thickness (without graphite layer)
A cross section of pellet
Z impedance

Comparison of the specific conductivity of the barrier layer catalyst (Example 1) and a carbon black (Ketjen Black EC300) and an electrocatalyst sample comprising 60% of Pt on carbon (HISPEC 9000; catalog No. 44171) which is customarily used for the electrocatalyst preparation is shown in Table 1. The catalyst from Example 1 is virtually nonconductive, in contrast to the reference materials.

TABLE 1
Comparison of the specific conductivity of Ketjen Black
EC300, HISPEC 900 and 10% Au/Al₂O₃ (Example 1)

| Catalyst | σ [S/cm] |
|---|---|
| Ketjen Black EC300 | 1.54 |
| HISPEC 9000 | 0.8 |
| 10% Au/Al₂O₃ (Example 1) | 4 * 10⁻⁷ |

### Example 4

### MeOH Permeation Experiments

MeOH permeation experiments are carried out in a 50 cm² fuel cell. Here, a membrane having a barrier layer from Example 2 is exposed at 50° C. to dry gas (100 ml/min) on one side and a methanolic solution (3.2% by weight; 100 ml/min) on the other side. During the experiment, condensate (25 ml) which has diffused through the membrane is collected on the dry side exposed to gas and the MeOH content is determined. The MeOH permeability is calculated from the time of the experiment and the amount of MeOH obtained. The experiment is then repeated at 60, 70, 80° C.

To determine the MeOH oxidation action of the barrier layer, N₂ and air are used as gas and the MeOH permeabilities determined are compared with one another. When air is used as gas, the permeabilities measured are significantly lower than in the case of N₂. Since the intrinsic permeability of the membrane used does not change during the experiment, the smaller amount of MeOH is attributable to the oxidation of MeOH in the barrier layer on the gas side of the fuel cell experiment. The corresponding values are reported in Tables 2 and 3.

TABLE 2
Use of N₂:

| | Time | Water | MeOH | MeOH permeability |
|---|---|---|---|---|
| Temperature | [min] | [g] | [g] | [mol/cm² * 2] |
| 50 | 278 | 6.26 | 0.34 | 2.55 * 10⁻⁸ |
| 60 | 245 | 9.19 | 0.31 | 2.64 * 10⁻⁸ |
| 70 | 220 | 13.44 | 0.36 | 3.41 * 10⁻⁸ |
| 80 | 275 | 22.5 | 0.45 | 3.41 * 10⁻⁸ |

TABLE 3
Use of air:

| | Time | Water | MeOH | MeOH permeability |
|---|---|---|---|---|
| Temperature | [min] | [g] | [g] | [mol/cm² * 2] |
| 50 | 245 | 5.11 | 0.09 | 7.65 * 10⁻⁹ |
| 60 | 220 | 7.38 | 0.12 | 1.14 * 10⁻⁸ |
| 70 | 190 | 9.94 | 0.16 | 1.75 * 10⁻⁸ |
| 80 | 197 | 15.35 | 0.25 | 2.64 * 10⁻⁸ |

1-14. (canceled)

15. A membrane-electrode assembly comprising at least one membrane, at least two electrode layers and at least one barrier layer, wherein the at least one barrier layer comprises at least one catalytically active species and at least one adsorbent material and the barrier layer is electronically nonconductive.

16. The membrane-electrode assembly according to claim 15, wherein the at least one barrier layer is present between an electrode layer and a membrane.

17. The membrane-electrode assembly according to claim 15 which has one membrane and two electrode layers.

18. The membrane-electrode assembly according to claim 15, wherein the membrane comprises one or more ion-conducting polymers.

19. The membrane-electrode assembly according to claim 15, wherein the catalytically active species is selected from among elements of transition groups VII, VIII, I and II of the Periodic Table of the Elements.

20. The membrane-electrode assembly according to claim 15, wherein the adsorbent material is selected from among zeolites, cationic polymer ion-exchange resins, activated carbon and highly porous oxide structures.

21. A process for producing a membrane-electrode assembly according to claim 15, which comprises
(a) applying at least one barrier layer comprising at least one catalytically active substance and at least one adsorbent material to at least one side of a membrane, wherein the barrier layer is electronically nonconductive and subsequently
(b) applying an electrode layer to each side of the membrane.

22. A gas diffusion electrode comprising a membrane-electrode assembly according to claim 15.

23. A fuel cell comprising a membrane-electrode assembly according to claim 15.
